(19) United States
(12) Patent Application Publication
(10) Pub. No.: US 2010/0082674 A1
(43) Pub. Date: Apr. 1, 2010

(54) SYSTEM FOR DETECTING USER INPUT ERROR

(75) Inventors: Paul Yiu, Mountain View, CA (US); Marc Davis, San Francisco, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/242,334

(22) Filed: Sep. 30, 2008

(51) Int. Cl. G06F 7/06; G06F 17/30

(52) U.S. Cl. 707/780; 707/E17.014

(57) ABSTRACT

A system is described for detecting user input error. The system may include a processor, a memory and an interface being operatively connected. The memory may store an item, existing items, and a match score of each existing item. The processor may receive the item input by the user, and a request to perform an action using the item, via the interface. The processor may identify the existing items relate to the requested action. The processor may calculate a match score of each of the existing items. The processor may identify the existing item which most closely matches the input item. The processor may alert the user if the match score of the closest matching existing item meets an alert criterion, and the closest matching existing item is not an exact match of the input item.

### TECHNICAL FIELD

The present description relates generally to a system and method, generally referred to as a system, for detecting user input error, and more particularly, but not exclusively, to detecting when a user incorrectly dials a telephone number, enters an email address, and/or enters a network address.

### BACKGROUND

Users may provide input to communication devices, such as mobile phones, to perform actions, such as making a phone call, sending an email, or browsing a web page. The input provided by a user may be a phone number for making a call, a uniform resource locator for browsing a web page, or an email address for sending an email. The user input may be susceptible to user error, such as a user may incorrectly dial a phone number.

### SUMMARY

A system is disclosed for detecting user input error. The system may include a processor, a memory and an interface. The memory may store an item, existing items, and a match score of each existing item. The interface may be operative for communicating with a user. The processor may receive the item input by the user, and a request to perform an action using the item, via the interface. The processor may identify the existing items relate to the requested action. The processor may calculate a match score of each of the existing items. The match score may indicate how closely an existing item matches the input item. The processor may identify the existing item which most closely matches the input item. The processor may alert the user if the match score of the closest matching existing item meets an alert criterion, and the closest matching existing item is not an exact match of the input item.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a system for detecting user input error.

FIG. 2 is a block diagram of a simplified view of a network environment implementing the system of FIG. 1 or other systems for detecting user input error.

FIG. 3 is a flowchart illustrating the operations of the system of FIG. 1, or other systems for detecting user input error.

FIG. 4 is a flowchart illustrating operations of using an exemplary alert criterion to detect user input error in the system of FIG. 1, or other systems for detecting user input error.

FIG. 5 is a flowchart illustrating operations of an exemplary calculation of match scores in the system of FIG. 1, or other systems for detecting user input error.

FIG. 6 is a flowchart illustrating operations of detecting user error when inputting a telephone number in the system of FIG. 1, or other systems for detecting user input error.

FIG. 7 is a flowchart illustrating operations of detecting user error when inputting an email address in the system of FIG. 1, or other systems for detecting user input error.

FIG. 8 is a flowchart illustrating operations of detecting user error when inputting a uniform resource locator in the system of FIG. 1, or other systems for detecting user input error.

FIG. 9 is an illustration of items tokenized for weighting in the system of FIG. 1, or other systems for detecting user input error.

FIG. 10 is an illustration a general computer system that may be used in a system for detecting user input error.

### DETAILED DESCRIPTION

The present description relates generally to a system and method, generally referred to as a system, for detecting user input error, and more particularly, but not exclusively, to detecting when a user incorrectly dials a telephone number.

User input error can yield the undesirable results of dialing an unintended telephone number, browsing to an unintended web page, or sending an email or text message to an unintended recipient. Thus, an incorrect input may be an input that does not match the user's intent. There may be a significant delay until the user becomes aware of these user input errors. For example, the user may be unaware that a phone number was dialed incorrectly until the call is connected. The delay in awareness of user input error can result in a loss of time, and potentially a loss of money due to connecting a phone call to the wrong phone number. In the example of a text message, the user may never be informed of the user input error.

The system may provide an alert to a user when a user incorrectly inputs an item on a device. The item may be associated with an action to be performed by the device, such as making a telephone call, browsing to a web page, sending a text message, or sending an email. The system may utilize a plurality of remote and local data sources of existing items, such as address books, call logs, and histories, to determine if the inputted item matches an existing item. The existing items may be known items, verified items, valid items, items previously accessed by the user, or items otherwise indicative of a correct user input. If the inputted item exactly matches an existing item in one of the data sources, or the inputted item is wholly distinct from all of the existing items, the system allows the device to perform the action with the inputted item. Otherwise if the inputted meets an alert criterion, such as the inputted item closely matches an existing item, the system alerts the user that the inputted item may have been entered incorrectly. The system may provide the user with the option of performing the requested action with the inputted item or with the closest matching existing item. The system provides an advantage over systems in the prior art by proactively detecting a potential user input error before performing the associated action, thereby saving both time and financial resources of the user.

The system may provide a user with suggested items as the user inputs characters. The suggested items may be the existing items in the data sources which match the characters entered by the user. For example, as the user types each number of a phone number, the system may provide the user with the phone numbers in the data sources that start with the numbers entered by the user. As the user enters additional numbers, the suggested items may be modified to reflect items which begin with the additional numbers. The items may be suggested to the user after the user inputs the first character. Alternatively or in addition the items may not be suggested until after the user has inputted a determined amount of characters. The amount of characters may be based on the may be based on the type of items, such as phone numbers, email addresses, or network addresses, the location of the user, or the number of suggested items matching the inputted characters.

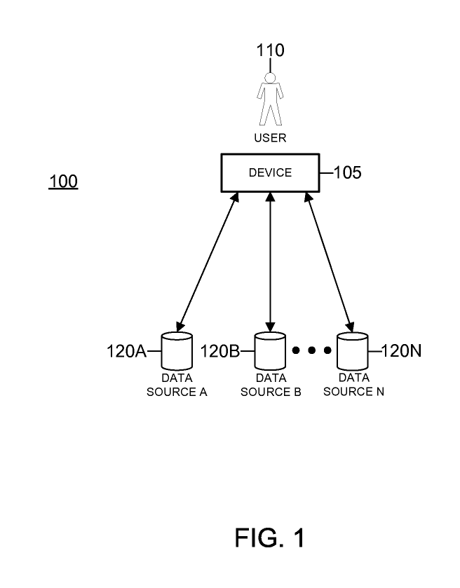

FIG. 1 provides a general overview of a system 100 for detecting user input error. Not all of the depicted components may be required, however, and some implementations may include additional components. Variations in the arrangement and type of the components may be made without departing from the spirit or scope of the claims as set forth herein. Additional, different or fewer components may be provided.

The system 100 may include a user 110, a device 105, such as a communication device, and one or more data sources 120A-N. The device 105 may be a computer, a mobile phone, personal digital assistant (PDA), pager, network-enabled television, digital video recorder, such as TIVO, automobile and/or any appliance capable of receiving input from the user 110. The data sources 120A-N may be local or remote data sources. A local data source may a data source stored on the device 105, while a remote data source may be a data source stored remotely, such as over a network. The data sources 120A-N may include phone or email address books, call, web, or email histories, web favorites, or generally any data source that may store items known, or previously accessed, by the user 110.

In operation, the user 110 may input an item to the device 105 and request the device 105 to perform an action associated with the item. For example, the item may be a phone number and the associated action may be dialing the phone number. Alternatively or in addition the item may be an email address and the associated action may be sending an email to the email address. Alternatively or in addition the item may be a uniform resource identifier (URI), such as a uniform resource locator (URL), and the action may be browsing to the URI. Generally the item may be any input provided by the user 110 associated with an action to be performed by the device 105.

The system 100 may intercept, or otherwise receive, the item and the action requested by the user 110. The system 100 may identify existing items stored in the data sources 120A-N which may match the inputted item. For example, in the case of a phone number, the system 100 may identify phone numbers in an address book of the user 110, phone numbers in a call history of the user 110, or phone numbers in the body of a text message sent or received by the user 110. The system 100 may determine whether the device 105 has access to remote data sources, such as via a network connection. If the device 105 has access to remote data sources, the system 100 may identify phone numbers stored in a remote data source, such as the phone numbers in the body of an email sent or received by the user 110.

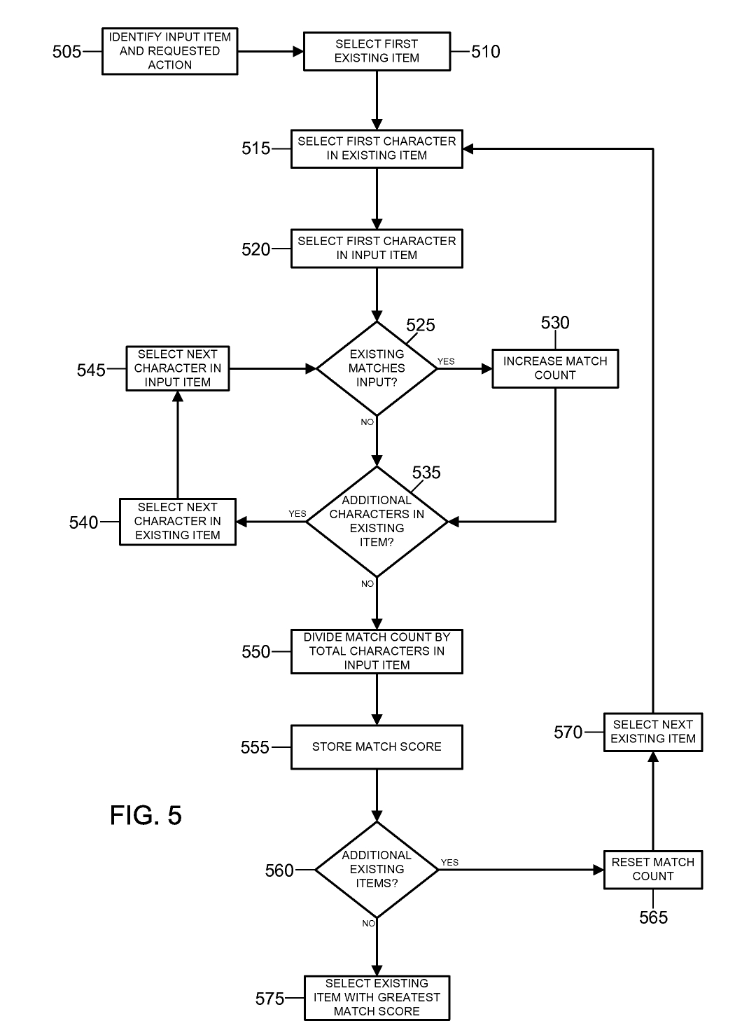

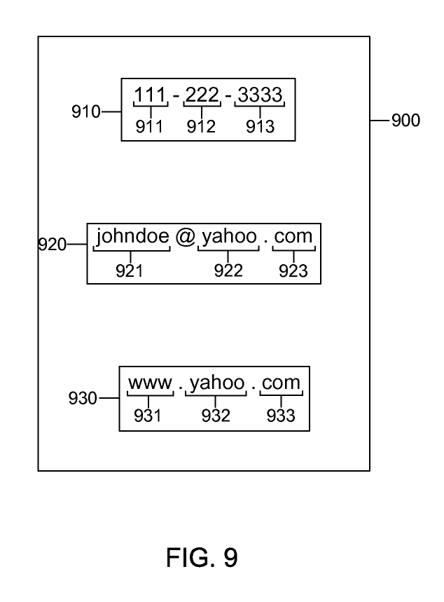

The system 100 may determine which of the existing items most closely matches the inputted item by calculating a match score for each of the existing items. The match score may represent a percentage of the existing item that matches the inputted item. The steps of calculating a match score for each of the existing items is discussed in more detail in FIG. 5 below. Alternatively or in addition the system 100 may weight the match score of each existing item depending on which segments of the existing item match the inputted item. For example, if there is a mismatch in the area code of an existing phone number, but the remainder of the existing phone number matches the inputted phone number exactly, there is high likelihood that the user 110 erred while inputting the area code, so the system 100 may weight the match score of the existing phone number. Weighting match scores is discussed in more detail in FIG. 9 below.

The system 100 may determine the existing item with the highest match score and determine whether the existing item meets an alert criterion. The alert criterion may be set to detect when the user 110 may have erred while inputting the item. For example, the alert criterion may be a match score threshold, such as when the match score of the existing item is greater than seventy-five, but less than one hundred. Alternatively the match score threshold may be when the match score of an existing item is greater than zero but less than twenty-five. Alternatively or in addition the system 100 may determine whether the inputted item meets an alert criterion. In this case the alert criterion may be set to detect if the item inputted by the user 110 is malformed in regards to the associated action. For example, if the inputted item is an email address the alert criterion may detect if the email address is missing a “@” or is otherwise malformed.

In the case of a phone number, the system 100 may verify that the user 110 dials the correct international dialing prefix when the user 110 dials international phone calls. The system 100 may determine the location of the user 110 based on a positioning service or other location detection mechanism, and may determine the location of the dialed number based on the number's country code. If the location of the user 110 is a different country than the location of the dialed phone number, then the system 100 may verify that the correct international dialing prefix was inputted by the user 110. The system 100 may determine the international dialing prefix based on the location of the user 110. If the user 110 did not input the correct international dialing prefix, the system 100 may automatically dial the international dialing prefix or may notify the user 110 of the international dialing prefix.

Alternatively or in addition, the system 100 may determine if the phone number inputted by the user 110 matches an existing phone number except for the country code. If the country code does not match, or is otherwise incorrect, the system 100 may notify the user 110 of the correct country code. Alternatively or in addition, if the user 110 inputs a phone number with an international prefix and country code, and the system 100 determines, based on the location of the user 110, that the prefix and country code are not necessary, the system 100 may remove the international dialing code and country code from the phone number. Alternatively or in addition the system 100 may notify the user 110 that the international dialing code and country code are not necessary at the current location of the user 110.

If the match score of the closest matching existing item does not meet the alert criterion, the system 100 allows the device 105 to perform the requested action with the inputted item, such as dial an inputted phone number. If the match score of the existing item meets the alert criterion, the system 100 may provide an alert to the user 110 indicating that the user 110 may have inputted the item incorrectly. The alert may include the closest matching existing item and may provide the user 110 with the option of performing the action with the closest matching existing item or with the inputted item.

The system 100 may be implemented on the device 105 through a software application stored locally on the device 105 or remotely on a third party server. The system 100 may be provided for free to the user 110 by a service provider, such as YAHOO!. Alternatively, the system 100 may be provided to the user 110 in exchange for allowing the service provider to access the local and remote data sources 120A-N of the user 110. Alternatively or in addition the system 100 may be provided to the user 110 in exchange for allowing the service provider to provide advertisements to the user 110 on the device 105. Alternatively the system 100 may be provided to the user 110 in exchange for allowing the service provider to monitor the items inputted incorrectly by the user. The service provider may use the incorrectly inputted items to generate a predictive model capable of more accurately determining when the user 110 may have inputted an item incorrectly. Generally the system 100 may be provided to the user 110 for free, for a fixed fee, or in exchange for data generated by the user 110 and/or the device 105 of value to a service provider.

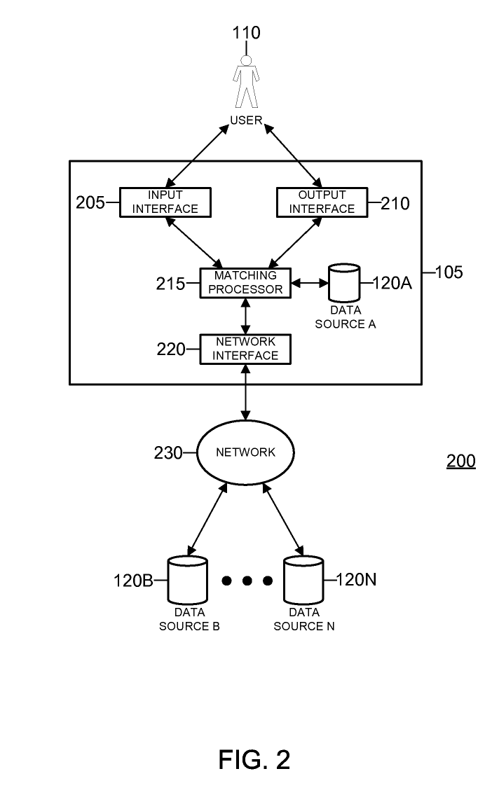

FIG. 2 provides a simplified view of a network environment implementing a system 200 for detecting user input error. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The system 200 may include a user 110, a device 105, a network 230, and one or more data sources 120A-N. The data source B 120B and the data source N 120N may be remote data sources, such as an email address book, a third party telephone listing service, or other remote resource. The device 105 may include an input interface 205, an output interface 210, a matching processor 215, a network interface 220 and a local data source A 120A. The input interface 205 may be a keypad, a touch screen, a voice command receiver, or generally any interface capable of receiving input from the user 110. The output interface 210 may be a speaker, a display screen, or generally any interface capable of providing an alert to the user 110. The matching processor 215 may be a processor capable of retrieving existing items from the data sources 120A-N, calculating the match scores of the existing items, and determining if the existing item with the greatest match score meets an alert criterion. The network interface 220 may provide communications from the device 105 to the remote data sources 120B-N, over the network 230.

The data sources 120A-N may be operative to store data, such as items known by the user 110 or previously accessed by the user 110. The data sources 120A-N may include one or more relational databases or other data sources that may be managed using various known database management techniques, such as, for example, SQL and object-based techniques. Alternatively or in addition the data sources 120A-N may be implemented using one or more of the magnetic, optical, solid state or tape drives.

The data sources 120A-N which are remote data sources may include online databases of phone numbers, such as business listings. The system 100 may use the online listings to determine if the user 110 dials a phone number existing in the online database. For example, if the user 110 dials a phone number, and the system 100 is unable to find any matches in the local data sources 120A-N, the system 100 may connect to an online database of phone numbers, such as a business directory. The system 100 may perform a lookup on the online database of phone numbers to determine if a number in the online database matches the number inputted by the user 110. If the system 100 finds a match, the system 100 may retrieve the name of the person or business associated with the phone number. The system 100 may display a notification to the user 110 indicating that the user 110 is about to call the business or person associated with the phone number. The user 110 may select to continue the call or cancel the call based on the notification provided by the system 100.

The network 230 may be configured to couple one computing device to another computing device to enable communication of data between the devices. The network 230 may generally be enabled to employ any form of machine-readable media for communicating information from one device to another. The network 230 may include one or more of a wireless network, a wired network, a local area network (LAN), a wide area network (WAN), a direct connection such as through a Universal Serial Bus (USB) port, and the like, and may include the set of interconnected networks that make up the Internet. The network 230 may include any communication method by which information may travel between computing devices. The network 230 may be regarded as a public or private network connection and may include, for example, a virtual private network or an encryption or other security mechanism employed over the public Internet, or the like. The network 230 may be divided into sub-networks. The sub-networks may allow access to all of the remote data sources 120B-N, or the sub-networks may restrict access between the remote data sources 120B-N.

The data connection between the network interface 220 and the network 230 may be a cellular connection, such as a GSM/GPRS/WCDMA connection, a wireless data connection, an internet connection, an infra-red connection, a Bluetooth connection, or any other connection capable of transmitting data.

In operation, the user 110 may input an item and request an associated action using the input interface 205. The matching processor 215 may identify existing items stored in the data sources 120A-N related to the associated action. The matching processor 215 may determine whether the network interface 220 is connected to the network 230. If the network interface 220 is not connected to the network 230, the matching processor 215 may only retrieve existing items from the data source A 120A. Alternatively, if the network interface 220 is connected to the network, the matching processor 215 may retrieve existing items from the local data source A 120A and one or more of the remote data sources 120B-N.

The matching processor 215 may calculate a match score for each of the existing items. The match score of an existing item may be the percentage of the existing item that matches the inputted item. The matching processor 215 may determine the existing item with the highest match score. The matching processor 215 may determine whether the highest match score meets an alert criterion, such as if the match score is greater than a threshold but less than one hundred. If the highest match score meets the alert criterion, the matching processor 215 may provide an alert to the user 110 through the output interface 210. The alert may indicate that the user 110 may have erred in inputting the item. Alternatively or in addition the alert may include the closest matching existing item and may provide the user 110 with the option of performing the action with the closest matching existing item or with the inputted item. If the user 110 chooses to perform the action with the closest matching existing item, the matching processor 215 may cause the device 105 to perform the action with the closest matching existing item. If the highest matching score does not meet the alert criterion, the matching processor 215 allows the device to perform the requested action with the inputted item, such as by not preventing the action from occurring.

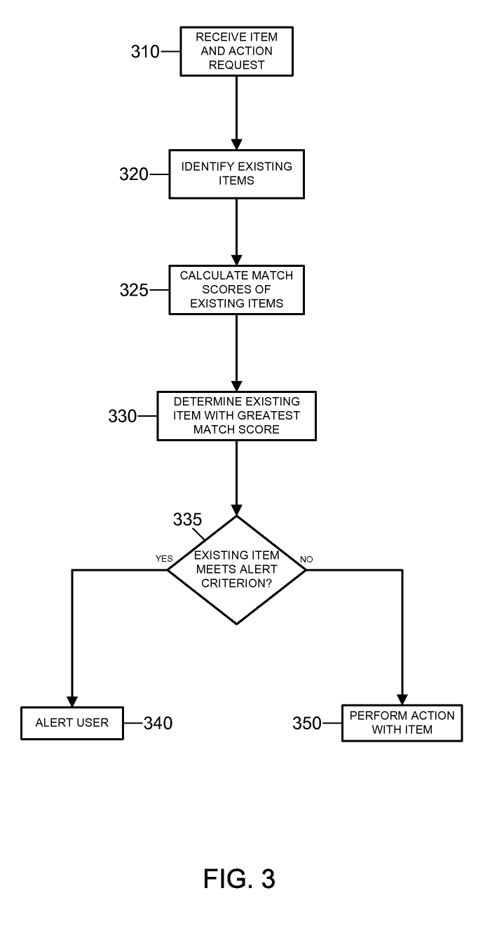

FIG. 3 is a flowchart illustrating the operations of the system of FIG. 1, or other systems for detecting user input error. At block 310 the system 100 may receive an inputted item and a requested action from a user 110 on a device 105. The user 110 may input the item by using a keypad on the device 105, using a touch screen on the device 105, using a microphone input on the device 105 to provide a voice command, or generally any manner of providing an input to the device 105. At block 320 the system 100 identifies existing items related to the associated action, such as existing items in the data sources 120A-N. At block 325 the system 100 calculates the match scores of the existing items. The match score of an existing item may reflect the percentage of the existing item that matches the inputted item. The steps of a calculating a match score may be discussed in more detail in FIG. 5 below. At block 330 the system 100 may determine the existing item that most closely matches the inputted item by identifying the existing item with the greatest match score.

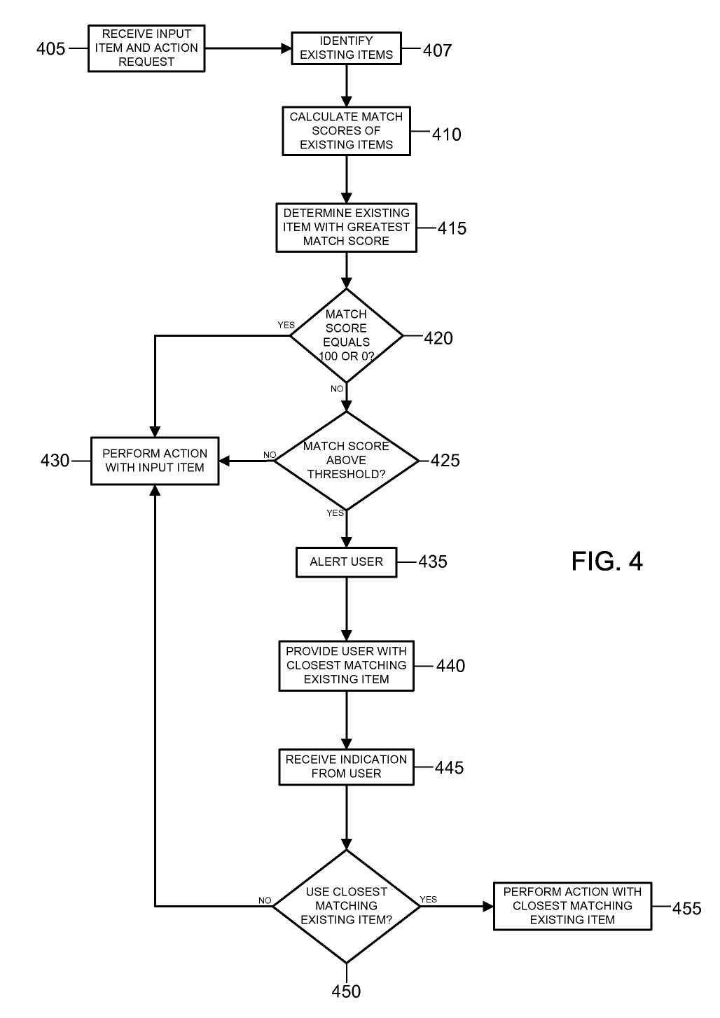

At block 335 the system 100 may determine whether the existing item with the greatest match score meets an alert criterion. The alert criterion may be set to detect when the user 110 may have intended to input the existing item, but due to user error inputted the item. For example, an alert criterion may be a match score threshold of the existing item, such as if the match score of the existing item is greater than fifty, but less than one hundred. An exemplary alert criterion is discussed in more detail in FIG. 4 below. If, at block 335, the system 100 determines that the existing item meets the alert criterion, the system 100 moves to block 340. At block 340 the system 100 may alert the user 110 that they may have erred in inputting the item. The system 100 may provide the closest matching existing item to the user 110, and may provide the user 110 with the option of performing the action with the closest matching existing item. If, at block 335, the system 100 determines that the match score of the closest matching existing item does not meet the alert criterion, the system 100 moves to block 350. At block 350 the system 100 allows the device 105 to perform the requested action with the inputted item.

FIG. 4 is a flowchart illustrating operations of using an exemplary alert criterion to detect user input error in the system of FIG. 1, or other systems for detecting user input error. At block 405 the system 100 receives an item inputted by the user 110 on the device 105 and an action requested by the user 110. At block 407 the system 100 identifies existing items related to the requested action, such as existing items stored in the data sources 120A-N. At block 410 the system 100 calculates match scores of the existing items. The match score of an existing item may represent the percentage of the existing item that matches the item inputted by the user 110. Calculating a match score of an existing item may be discussed in more detail in FIG. 5 below. At block 415 the system 100 determines the existing item with the greatest match score. Alternatively or in addition the system 100 may perform an initial analysis of the inputted item to verify that the inputted item complies with the formatting associated with the requested action. For example, in the case of a telephone number, the system 100 may verify that the phone number is the correct length. If the phone number is not the correct length, the system 100 may provide an alert to the user 110 indicating that the length of the phone number is incorrect.

At block 420 the system 100 may determine if the match score equals zero or one hundred. If the match score equals one hundred, then the closest matching existing item is an exact match to the inputted item, and there may be a high likelihood that the user 110 intended to input the matching existing item. Alternatively if the match score is zero then all of the existing items are wholly distinct from the inputted item, and there may be a high likelihood that the user 110 intended to input a wholly new item. If, at block 420, the match score equals zero or one hundred, the system 100 moves to block 430. At block 430 the system 100 allows the device 105 to perform the requested action with the item inputted by the user 110.

If, at block 420, the match score does not equal zero or one hundred, the system 100 moves to block 425. At block 425 the system 100 determines if the match score is above an alert threshold. The alert threshold may be set to detect when the user 110 intended to input an existing item, but, due to user error, inputted the existing item incorrectly. For example, the alert threshold may be set to eighty, which may detect any items inputted by the user 110 which match eighty percent of an existing item. If, at block 425, the alert score is below an alert threshold, the system 100 may move to block 430. At block 430 the system 100 may allow the device 105 to perform the action with the item inputted by the user 110.

If, at block 425, the match score is above the alert threshold, the system 100 may move to block 435. At block 435 the system 100 may alert the user 110 that the user 110 may have inputted the item incorrectly. At block 440 the system 100 may provide the user 110 with the closest matching existing item, which may be the item the user 110 intended to input. The system 100 may provide the user 110 with the option of performing the action with the existing item or with the inputted item. Alternatively or in addition the system 100 may provide the user 110 with the option of editing the existing or inputted item, or inputting a new item altogether. Alternatively or in addition the system 100 may provide the user 110 with multiple existing items that closely match the inputted item. At block 445 the system 100 may receive an indication from the user 110 of whether to perform the requested action with the inputted item or the closest matching existing item. At block 450 the system 100 may determine whether the user 110 selected to use the closest matching item or the inputted item to perform the action.

If, at block 450, the user 110 selected to perform the requested action with the inputted item, the system 100 may move to block 430. At block 430 the system 100 may perform the requested action with the inputted item. If, at block 450, the user 110 selected to perform the requested action using the closest matching existing item, then the system 100 moves to block 455. At block 455 the system 100 causes the device 105 to perform the requested action with the closest matching existing item.

FIG. 5 is a flowchart illustrating operations of an exemplary calculation of match scores the system of FIG. 1, or other systems for detecting user input error. At block 505 the system 100 may identify the item inputted by the user 110 and the action requested by the user 110. At block 510 the system 100 may identify existing items related to the requested action, and select the first existing item. At block 515 the system 100 may select the first character in the selected existing item. At block 520 the system 100 may select the first character of the inputted item. Alternatively or in addition, if the inputted item was not provided via a text entry, such as by a voice command, the system 100 may convert the inputted item to a string of characters describing the inputted item. Alternatively or in addition, the system 100 may screen the input item to verify the input item meets formatting requirements associated with the requested action, such as the length of a phone number or the format of a URL or email address. At block 525 the system 100 may determine if the selected character of the existing item matches the selected character of the inputted item. If the characters match, the system 100 moves to block 530. At block 530 the system 100 increments a match count of the existing item. If, at block 525, the character of the existing item does not match the inputted item then the system 100 moves to block 535.

At block 535 the system 100 determines if there are additional characters in the existing item. If, at block 535, there are additional characters in the existing item, the system 100 may move to block 540. At block 540 the system 100 may select the next character in the existing item. At block 545 the system 100 may select the next character in the inputted item. The system 100 may then move to block 525 and repeat the process for each additional character in the existing item.

If, at block 535, there are no additional characters in the existing item, the system 100 moves to block 550. At block 550 the system 100 calculates the match score of the existing item. The match score of the existing item may be calculated by dividing the match count for the existing item by the total number of characters in the input item. Alternatively or in addition the resulting value may be multiplied by one hundred. At block 555 the system 100 may store the match score of the existing item in a local memory. At block 560 the system 100 may determine if there are additional identified existing items. If, at block 560, the system 100 determines that there are additional identified existing items, the system 100 moves to block 565. At block 565 the system 100 resets the match count. At block 570 the system 100 selects the next identified existing item. The system 100 then moves to block 515 and repeats the process for the next identified existing item. The system 100 may repeat this process for each of the identified existing items. If, at block 560, the system 100 determines that there are no additional identified existing items, the system 100 may move to block 575. At block 575 the system 100 may return the existing item with the highest match score.

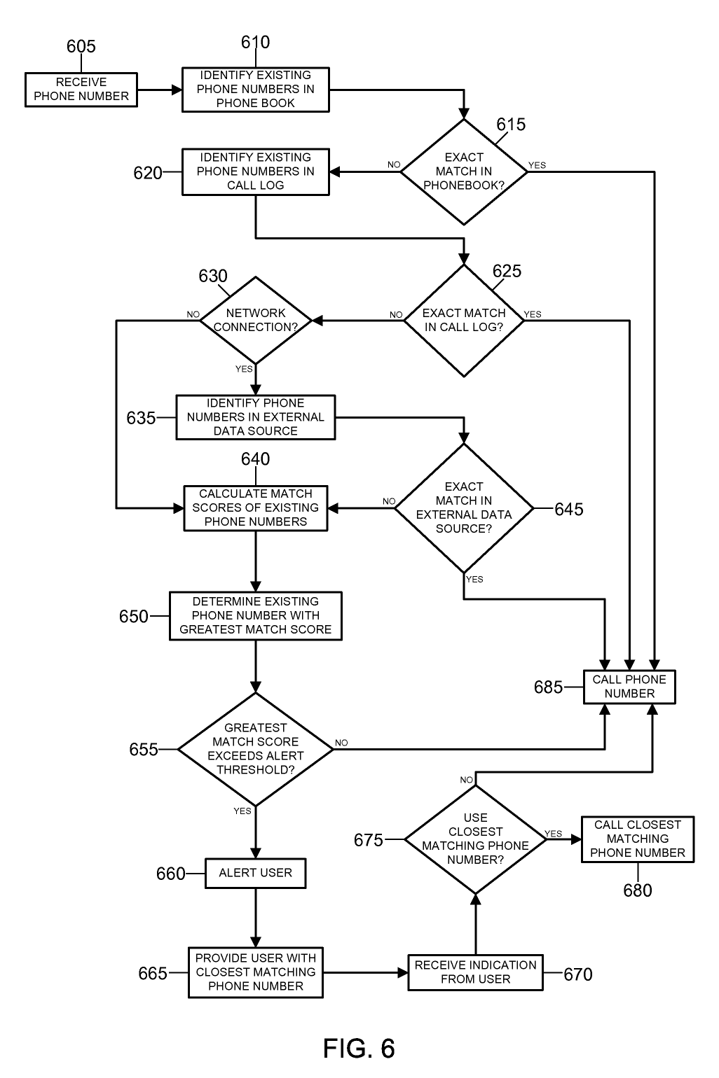

FIG. 6 is a flowchart illustrating operations of detecting user error when inputting a telephone number in the system of FIG. 1, or other systems for detecting user input error. At block 605 the system 100 may receive a phone number inputted by the user 110 on the device 105. The inputted phone number may be associated with a phone call to be performed by the device 105. At block 610 the system 100 may identify existing phone numbers in the local phone book on the device 105 of the user 110. At block 615 the system 100 may determine whether there is an exact match of the inputted phone number in the phone book. If there is an exact match of the inputted phone number in the phone book, then there is a high probability that the user 110 intended to dial the number in the phone book, and inputted the number correctly. If, at block 615, the system 100 determines there is an exact match of the inputted phone number in the phone book, the system 100 moves to block 685. At block 685 the system 100 allows the device to perform the phone call with the inputted phone number.

If, at block 615, the system 100 determines there is not an exact match in the phone book on the device 105 of the user 110, the system 100 moves to block 620. At block 620 the system 100 identifies the existing phone numbers in the local call log on the device 105 of the user 110. The existing phone numbers in the local call log may represent phone numbers that the user 110 received calls from or phone numbers that the user 110 made calls to. Alternatively or in addition, the system 100 may filter previously misdialed numbers from the call log by only identifying phone numbers associated with a connected call, or phone numbers associated with calls that lasted for a minimum duration of time. Alternatively or in addition, the system 100 may only identify phone numbers dialed by the user 110, not phone numbers of calls received by the user 110.

At block 625, the system 100 may determine whether there is an exact match of the inputted phone number in the call log of the device 105. If, at block 625, there is an exact match in the call log of the device 105, the system 100 moves to block 685. At block 685 the system 100 allows the device 105 to perform the phone call with the inputted phone number. If, at block 625, the system 100 determines that there is not an exact match of the inputted phone number in the call log of the device 105, the system 100 moves to block 630. At block 630 the system 100 determines if there is a connection from the device 105 to the network 230. If, at block 630, the system 100 determines there is a connection from the device 105 to the network 230, then the system 100 moves to block 635. At block 635 the system 100 connects to an external data source, such as an external email server, and identifies existing phone numbers stored in the external data source. At block 645 the system 100 determines whether there is an exact match between the inputted phone number and an existing phone number in the external data source. If, at block 645, the system 100 determines that there is an exact match, the system 100 moves to block 685. At block 685, the system 100 allows the device 105 to perform the phone call with the inputted phone number.

If, at block 645, the system 100 determines there is not an exact match with an existing phone number in the external data source, then the system 100 moves to block 640. If, at block 630, the system 100 determines there is not an active connection between the device 105 and the network 230, the system 100 moves to block 640. At block 640, the system 100 calculates the match scores of the existing phone numbers in each of the data sources 120A-N. The match score of an existing phone number may represent the percentage of the existing phone number that matches the inputted phone number. At block 650 the system 100 determines the existing telephone number with the greatest match score.

At block 655 the system 100 may determine whether the greatest match score exceeds an alert threshold. A match score of an existing telephone number exceeding the alert threshold may indicate a high likelihood that the user 110 erred in entering the inputted telephone number, and intended to input the existing telephone number. For example, the alert threshold may be set to eighty; in this case, any match score higher than eighty may indicate a high likelihood that the user 110 erred while inputting the telephone number. If, at block 655, the system 100 determines that the greatest match score does not exceed the alert threshold, then the system 100 moves to block 685. At block 685 the system 100 allows the device 105 to perform the call with the inputted number.

If, at block 655, the system 100 determines that the greatest match score exceeds the alert threshold, the system 100 moves to block 660. At block 660 the system 100 alerts the user 110 that the user 110 may have inputted the phone number incorrectly. At block 665 the system 100 provides the user with the existing phone number that most closely matches the phone number inputted by the user 110. The system 100 may provide the user 110 with the option of selecting to perform the telephone call with the closest matching existing phone number or the inputted phone number. At block 670 the system 100 may receive an indication from the user 110 of whether to perform the telephone call with the inputted phone number or with the closest matching existing phone number.

At block 675 the system 100 determines whether the user 110 selected to use the inputted phone number to perform the telephone call or to use the closest matching existing phone number. If, at block 675, the user 110 selects to use the inputted phone number, the system 100 moves to block 685. At block 685, the system 100 allows the device to perform the call using the inputted phone number. If, at block 675, the user 110 selects to perform the call using the closest matching existing phone number the system 100 moves to block 680. At block 680 the system 100 causes the device 105 to perform the phone call using the closest matching existing phone number.

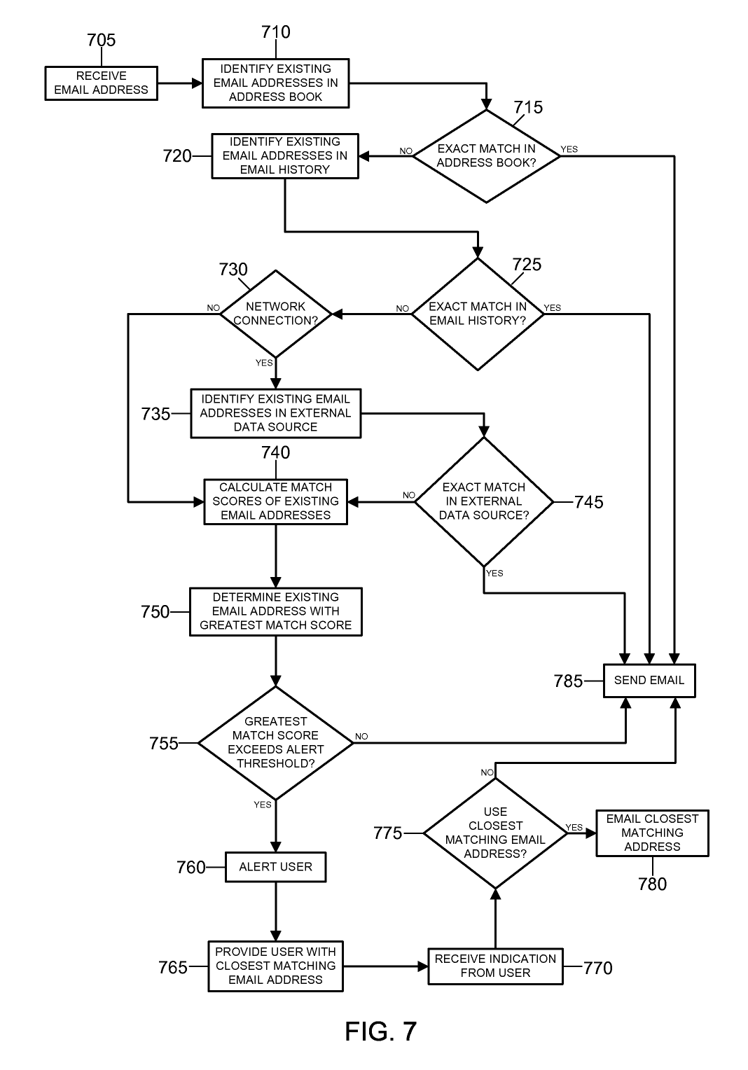

FIG. 7 is a flowchart illustrating operations of detecting user input error in entering an email address in the system of FIG. 1, or other systems for detecting user input error. At block 705 the system 100 may receive an email address inputted by the user 110 on the device 105. The email address may be associated with an email to be sent by the device 105. At block 710 the system 100 may identify existing email addresses in the local email address book on the device 105 of the user 110. At block 715 the system 100 may determine whether there is an exact match of the inputted email address in the email address book. If there is an exact match of the inputted email address in the email address book, then there is a high probability that the user 110 intended to send an email to the email address in the email address book, and typed the email address correctly. If, at block 715, the system 100 determines there is an exact match of the inputted email address in the email address book, the system 100 moves to block 785. At block 785 the system 100 allows the device to send the email with the inputted email address.

If, at block 715, the system 100 determines there is not an exact match in the email address book on the device 105 of the user 110, the system 100 moves to block 720. At block 720 the system 100 identifies the existing email addresses in the email history on the device 105 of the user 110. The existing email addresses in the email history may represent email addresses the user 110 received emails from, and email addresses the user 110 sent emails to. Alternatively or in addition, the system 100 may only identify email addresses of emails sent by the user 110, not email addresses of emails received by the user 110.

At block 725, the system 100 may determine whether there is an exact match of the inputted email address in the email history of the device 105. If, at block 725, there is an exact match in the email history of the device 105, the system 100 moves to block 785. At block 785 the system 100 allows the device 105 to send the email to the inputted email address. If, at block 725, the system 100 determines that there is not an exact match of the inputted email address in the email history of the device 105, the system 100 moves to block 730. At block 730 the system 100 determines if there is a connection from the device 105 to the network 230. If, at block 730, the system 100 determines that there is a connection from the device 105 to the network 230, then the system 100 moves to block 735. At block 735 the system 100 connects to an external data source, such as an external email server, and identifies existing email addresses stored in the external data source. At block 745 the system 100 determines whether there is an exact match between the inputted email address and an existing email address in the external data source. If, at block 745, the system 100 determines that there is an exact match, the system 100 moves to block 785. At block 785, the system 100 allows the device 105 to send the email to the inputted email address.

If, at block 745, the system 100 determines there is not an exact match with an existing email address in the external data source, then the system 100 moves to block 740. If, at block 730, the system 100 determines there is not an active connection between the device 105 and the network 230, the system 100 moves to block 740. At block 740, the system 100 calculates the match scores of the existing email addresses in each of the data sources 120A-N. The match score of an existing email address may represent the percentage of the existing email address that matches the inputted email address. At block 750 the system 100 determines the existing email address with the greatest match score.

At block 755 the system 100 may determine whether the greatest match score exceeds an alert threshold. A match score of an existing email address exceeding the alert threshold may indicate a high likelihood that the user 110 erred in entering the inputted email address, and intended to input the existing email address. For example, the alert threshold may be set to eighty; in this case a greatest match score higher than eighty would indicate a high likelihood that the user 110 erred while inputting the email address. If, at block 755, the system 100 determines that the greatest match score does not exceed the alert threshold, then the system 100 moves to block 785. At block 785 the system 100 allows the device 105 to send the email to the inputted email address.

If, at block 755, the system 100 determines that the greatest match score exceeds the alert threshold, the system 100 moves to block 760. At block 760 the system 100 alerts the user 110 that the user 110 may have inputted the email address incorrectly. At block 765 the system 100 provides the user 110 with the existing email address most closely matching the email address inputted by the user 110. The system 100 may provide the user 110 with the option of selecting to send the email to the closest matching existing email address, or to send the email to the inputted email address. At block 770 the system 100 may receive an indication from the user 110 of whether to send the email to the inputted email address or the closest matching existing email address.

At block 775 the system 100 determines whether the user 110 selected to send the email to the inputted email address, or to send the email to the closest matching email address. If, at block 775, the user 110 selects to send the email to the inputted email address, the system 100 moves to block 785. At block 785, the system 100 allows the device to send the email to the inputted email address. If, at block 775, the user 110 selects to send the email to the closest matching existing email address, the system 100 moves to block 780. At block 780 the system 100 causes the device 105 to send the email to the closest matching existing email address.

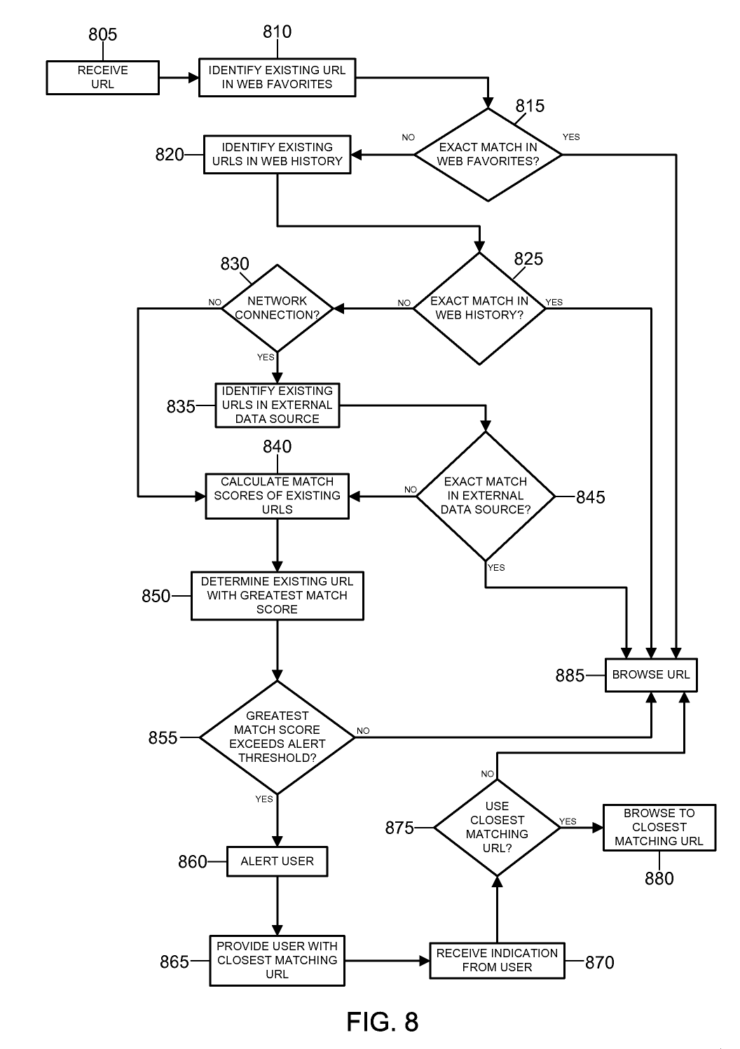

FIG. 8 is a flowchart illustrating operations of detecting user input error in entering a uniform resource locator in the system of FIG. 1, or other systems for detecting user input error. At block 805 the system 100 may receive a URL inputted by the user 110 on the device 105. The URL may be associated with a request to retrieve the web page represented by the URL on the device 105. At block 810 the system 100 may identify existing URLs in the local web favorites on the device 105 of the user 110. At block 815 the system 100 may determine whether there is an exact match of the inputted URL in the web favorites. If there is an exact match of the inputted URL in the web favorites, then there is a high probability that the user 110 intended to browse to the URL in the web favorites, and inputted the URL correctly. If, at block 815, the system 100 determines there is an exact match of the inputted URL in the web favorites, the system 100 moves to block 885. At block 885 the system 100 allows the device to retrieve the web page associated with the inputted URL.

If, at block 815, the system 100 determines there is not an exact match in the web favorites on the device 105 of the user 110, the system 100 moves to block 820. At block 820 the system 100 identifies the existing URLs in the web history on the device 105 of the user 110. The existing URLs in the web history may represent URLs that the user 110 has previously accessed. At block 825, the system 100 may determine whether there is an exact match of the inputted URL in the web history of the device 105. If, at block 825, there is an exact match in the web history of the device 105, the system 100 moves to block 885. At block 885 the system 100 allows the device 105 to retrieve the web page associated with the inputted URL. If, at block 825, the system 100 determines that there is not an exact match of the inputted URL in the web history of the device 105, the system 100 moves to block 830.

At block 830 the system 100 determines if there is a connection from the device 105 to the network 230. If, at block 830, the system 100 determines there is a connection from the device 105 to the network 230, then the system 100 moves to block 835. At block 835 the system 100 connects to an external data source, such as a web history on an external computer, and identifies existing URLs stored in the external data source. At block 845 the system 100 determines whether there is an exact match between the inputted URL and the existing URLs in the external data source. If, at block 845, the system 100 determines there is an exact match in the external data source, the system 100 moves to block 885. At block 885, the system 100 allows the device 105 to retrieve the web page associated with the inputted URL.

If, at block 845, the system 100 determines there is not an exact match with an existing URL in the external data source, the system 100 moves to block 840. If, at block 830, the system 100 determines there is not an active connection between the device 105 and the network 230, the system 100 moves to block 840. At block 840, the system 100 calculates the match scores of the existing URLs in each of the data sources 120A-N. The match score of an existing URL may represent the percentage of the existing URL that matches the inputted URL. At block 850 the system 100 determines the existing URL with the greatest match score.

At block 855 the system 100 may determine whether the greatest match score exceeds an alert threshold. A match score of an existing URL exceeding the alert threshold may indicate a high likelihood that the user 110 erred in entering the inputted URL, and intended to input the existing URL. For example, the alert threshold may be set to eighty; in this case any match score higher than eighty would indicate a high likelihood that the user 110 erred while inputting the URL. If the match score does not exceed the alert threshold then there is a high likelihood that the user 110 intends to browse to a new URL and did not error in entering the URL. If, at block 855, the system 100 determines that the greatest match score does not exceed the alert threshold, then the system 100 moves to block 885. At block 885 the system 100 allows the device 105 to retrieve the web page associated with the inputted URL.

If, at block 855, the system 100 determines that the greatest match score exceeds the alert threshold, the system 100 moves to block 860. At block 860 the system 100 alerts the user 110 that the user 110 may have inputted the URL incorrectly. At block 865 the system 100 provides the user 110 with the existing URL most closely matching the URL inputted by the user 110. The system 100 may provide the user 110 with the option of selecting to browse to the closest matching existing URL, or to browse to the inputted URL. At block 870 the system 100 may receive an indication from the user 110 of whether to browse to the inputted URL or the closest matching URL.

At block 875 the system 100 determines whether the user 110 selected to browse to the inputted URL, or to browse to the closest matching URL. If, at block 875, the user 110 selects to browse to the inputted URL, the system 100 moves to block 885. At block 885, the system 100 allows the device to retrieve the web page associated with the inputted URL. If, at block 875, the user 110 selects to browse to the closest matching existing URL, the system 100 moves to block 880. At block 880 the system 100 causes the device 105 to retrieve the web page associated with the closest matching existing URL.

FIG. 9 is an illustration of items 900 tokenized for weighting in the system of FIG. 1, or other systems for detecting user input error. The tokenized items 900 may include a phone number 910, an email address 920, and a network address, such as a URL 930. The phone number item 910 may include a first phone token 911, a second phone token 912, and a third phone token 913. The email address item 920 may include a first email token 921, a second email token 922, and a third email token 923. The URL item 930 may include a first URL token 931, a second URL token 932, and a third URL token 933.

The system 100 may tokenize each of the items 910, 920, 930 and may apply a separate weight to the characters contained in each token. The system 100 may use the weighting of the characters to incorporate real world attributes associated with each of the items 910, 920, 930 to the detection of user input error. For example, a real world attribute of a phone number might indicate there are many phone numbers which share the first phone token 911, and the second phone token 912, but not the third phone token 913. Thus, matches of these tokens, along with a mismatch of the third phone token 913, should be less indicative of a user input error. However the real world attribute may indicate that there are few phone numbers which share the second phone token 912 and the third phone token 913. Thus, matches of these tokens, along with a mismatch of the first phone token 911, may be more indicative of a user input error.

In the case of the email address 920, a real world attribute may indicate that many email addresses share the second email token 922, and the third email token 923, but not the first email token 921. Thus, a match of the first email token 921, and the second email token 922, or the third email token 923, may be highly indicative of a user input error. In the case of a URL 930, a real world attribute may indicate that many URLs share the first URL token 931, and the third URL token 933, but not the second URL token 932. Thus a match of the second URL token 932, and the first email token 931, or the third email token 933, may be highly indicative of a user input error.

In order to incorporate the real world attributes of the items 910, 920, 930, the system 100 may apply a different weight to the characters contained in the tokens of each item. The weight may be applied to a character match within the token. Thus, instead of incrementing the match count by one for a character match, the match count may be incremented by one multiplied by the weight assigned to the token the character is contained in. The weights applied to each token may differ for each of the items 910, 920, 930; however, generally the weights should apply additional value to the tokens which are more indicative of a user input error when matched, and less value to the tokens which are less indicative of a user input error when matched. The weights applied to each token should ensure that an exact match still results in a match score of one, or one hundred after being multiplied by one hundred.

For example, in the case of the phone number item 910, character matches in the first phone token 911 and the second phone token 912 may be multiplied by two-thirds (⅔). Character matches in the third phone token 913 may be multiplied by three-halves ( 3/2). Since there are three characters in the first phone token 911, and the second phone token 912, an exact match of one of these tokens will result in a weighted match count of three multiplied by two-thirds (⅔), which equals two. Since there are four characters in the third phone token 913, an exact match of the third phone token 913 will result in a weighted match of three multiplied by three-halves ( 3/2), which equals six. Thus, an exact match of all three phone tokens 911, 912, 913 will result in a weighted match count of two plus two plus six, which equals ten. After dividing the match count by the total number of characters in the phone number, ten, the weighted match score of an exact match will be one, and multiplying the score by one hundred will result in one hundred. Generally any weighting algorithm capable of reflecting real world attributes may be applied to the items 910, 920, 930.

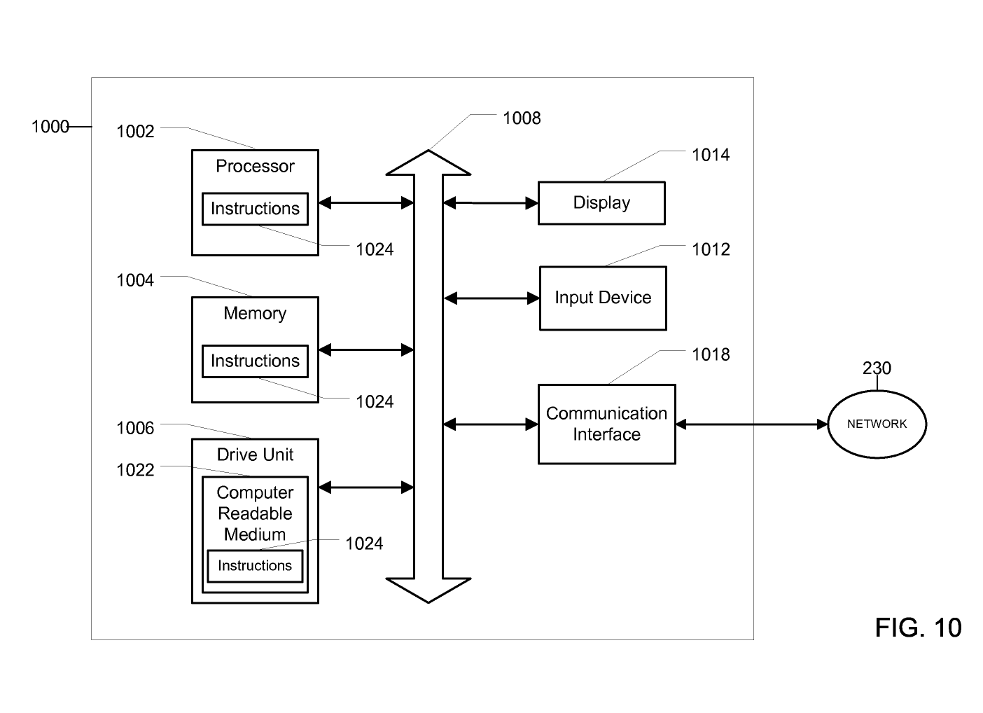

FIG. 10 illustrates a general computer system 1000, which may represent a device 105, or any of the other computing devices referenced herein. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The computer system 1000 may include a set of instructions 1024 that may be executed to cause the computer system 1000 to perform any one or more of the methods or computer based functions disclosed herein. The computer system 1000 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 1000 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 1024 (sequential or otherwise) that specify actions to be taken by that machine. In a particular embodiment, the computer system 1000 may be implemented using electronic devices that provide voice, video or data communication. Further, while a single computer system 1000 may be illustrated, the term “system” shall also be taken to include any collection of systems or sub-systems that individually or jointly execute a set, or multiple sets, of instructions to perform one or more computer functions.

As illustrated in FIG. 10, the computer system 1000 may include a processor 1002, such as, a central processing unit (CPU), a graphics processing unit (GPU), or both. The processor 1002 may be a component in a variety of systems. For example, the processor 1002 may be part of a standard personal computer or a workstation. The processor 1002 may be one or more general processors, digital signal processors, application specific integrated circuits, field programmable gate arrays, servers, networks, digital circuits, analog circuits, combinations thereof, or other now known or later developed devices for analyzing and processing data. The processor 1002 may implement a software program, such as code generated manually (i.e., programmed).

The computer system 1000 may include a memory 1004 that can communicate via a bus 1008. The memory 1004 may be a main memory, a static memory, or a dynamic memory. The memory 1004 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 1004 may include a cache or random access memory for the processor 1002. Alternatively or in addition, the memory 1004 may be separate from the processor 1002, such as a cache memory of a processor, the system memory, or other memory. The memory 1004 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 1004 may be operable to store instructions 1024 executable by the processor 1002. The functions, acts or tasks illustrated in the figures or described herein may be performed by the programmed processor 1002 executing the instructions 1024 stored in the memory 1004. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 1000 may further include a display 1014, such as a liquid crystal display (LCD), an organic light emitting diode (OLED), a flat panel display, a solid state display, a cathode ray tube (CRT), a projector, a printer or other now known or later developed display device for outputting determined information. The display 1014 may act as an interface for the user to see the functioning of the processor 1002, or specifically as an interface with the software stored in the memory 1004 or in the drive unit 1006.

Additionally, the computer system 1000 may include an input device 1012 configured to allow a user to interact with any of the components of system 1000. The input device 1012 may be a number pad, a keyboard, or a cursor control device, such as a mouse, or a joystick, touch screen display, remote control or any other device operative to interact with the system 1000.

The computer system 1000 may also include a disk or optical drive unit 1006. The disk drive unit 1006 may include a computer-readable medium 1022 in which one or more sets of instructions 1024, e.g. software, can be embedded. Further, the instructions 1024 may perform one or more of the methods or logic as described herein. The instructions 1024 may reside completely, or at least partially, within the memory 1004 and/or within the processor 1002 during execution by the computer system 1000. The memory 1004 and the processor 1002 also may include computer-readable media as discussed above.

The present disclosure contemplates a computer-readable medium 1022 that includes instructions 1024 or receives and executes instructions 1024 responsive to a propagated signal; so that a device connected to a network 230 may communicate voice, video, audio, images or any other data over the network 230. The instructions 1024 may be implemented with hardware, software and/or firmware, or any combination thereof. Further, the instructions 1024 may be transmitted or received over the network 230 via a communication interface 1018. The communication interface 1018 may be a part of the processor 1002 or may be a separate component. The communication interface 1018 may be created in software or may be a physical connection in hardware. The communication interface 1018 may be configured to connect with a network 230, external media, the display 1014, or any other components in system 1000, or combinations thereof. The connection with the network 230 may be a physical connection, such as a wired Ethernet connection or may be established wirelessly as discussed below. Likewise, the additional connections with other components of the system 1000 may be physical connections or may be established wirelessly. In the case of a device 105, the communication interface 1018 may be the network interface 220.

The network 230 may include wired networks, wireless networks, or combinations thereof. The wireless network may be a cellular telephone network, an 802.11, 802.16, 802.20, or WiMax network. Further, the network 230 may be a public network, such as the Internet, a private network, such as an intranet, or combinations thereof, and may utilize a variety of networking protocols now available or later developed including, but not limited to TCP/IP based networking protocols.

The computer-readable medium 1022 may be a single medium, or the computer-readable medium 1022 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 1022 may include a solid-state memory such as a memory card or other package that houses one or more non-volatile read-only memories. The computer-readable medium 1022 also may be a random access memory or other volatile re-writable memory. Additionally, the computer-readable medium 1022 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A computer implemented method of detecting an incorrect input, comprising:
receiving an item input by a user and a request to perform an action using the item;
identifying a plurality of existing items, each existing item related to the requested action;
calculating a match score of each existing item, the match score indicating how closely each existing item matches the input item; and
identifying a closest matching existing item, the closest matching existing item comprising of the existing item which most closely matches the input item; and
alerting the user if the match score of the closest matching existing item meets an alert criterion and the closest matching existing item is not an exact match of the input item.

2. The computer implemented method of claim 1 wherein the match score corresponds to a percentage of the existing item which matches the input item.

3. The computer implemented method of claim 1 further comprising alerting the user if the closest matching existing item is wholly distinct from the input item.

4. The computer implemented method of claim 1 further comprising alerting the user if the inputted item is not formatted in accordance with a format associated with the action.

5. The computer implemented method of claim 1 wherein the match score of the closest matching existing item meets an alert criterion if the match score exceeds an alert threshold.

6. The computer implemented method of claim 1 wherein the input item comprises a telephone number.

7. The computer implemented method of claim 6 wherein allowing the action to be performed using the input item further comprises allowing a phone call to be dialed using the telephone number.

8. The computer implemented method of claim 6 wherein the plurality of existing items comprises of a plurality of telephone numbers in an address book.

9. The computer implemented method of claim 8 wherein the address book is stored remotely from the device.

10. The computer implemented method of claim 6 wherein the plurality of existing items comprises of a plurality of telephone numbers in a call log.

11. The computer implemented method of claim 1 wherein alerting the user further comprises:
providing the existing item to the user;
receiving an indication from the user whether the associated action should be performed using the existing item with the greatest match score or the input item; and
causing the action to be performed based on the indication received from the user.

12. The computer implemented method of claim 1 wherein the item is input by a voice command.

13. The computer implemented method of claim 1 wherein the item is input by a keypad entry.

14. The computer implemented method of claim 1 wherein the device comprises a phone.

15. The computer implemented method of claim 1 wherein the input item comprises a uniform resource identifier.

16. The computer implemented method of claim 1 wherein the input item comprises an email address.

17. The computer implemented method of claim 1 wherein calculating a match score of each existing item further comprising applying a weight to the match score of each existing item.

18. The computer implemented method of claim 17 wherein the weight is indicative of a real world attribute of the existing items.

19. A computer implemented method for detecting an incorrectly dialed telephone number, comprising:
receiving a telephone number input by a user on a device to perform a call, the telephone number comprising a plurality of ordered characters;
identifying a plurality of existing telephone numbers wherein each existing telephone number comprises a plurality of ordered characters;
calculating a match score of each existing telephone number, the match score corresponding to a percentage of existing ordered characters of the existing telephone number which match the ordered characters of the input telephone number;
identifying a closest matching existing telephone number, the closest matching existing telephone number comprising of the existing telephone number which most closely matches the input telephone number; and
alerting the user if the match score of the closest matching existing telephone number meets an alert criterion and the closest matching existing telephone number is not an exact match of the input telephone number.

20. The computer implemented method of claim 19 wherein the plurality of existing items comprises of a plurality of telephone numbers in an address book.

21. The computer implemented method of claim 19 wherein the address book is stored remotely from the device.

22. The computer implemented method of claim 19 wherein alerting the user of the existing telephone number further comprises:
providing the existing telephone number to the user;
receiving an indication from the user whether to use the existing telephone number or the input telephone number to perform the call; and
causing the call to be performed based on the indication received from the user.

23. The computer implemented method of claim 19 wherein identifying a plurality of existing telephone numbers further comprises:
determining whether a network connection exists; and
retrieving the plurality of telephone numbers from a remote location if a network connection exists, otherwise retrieving the plurality of telephone numbers from a location on the device.

24. A system for detecting an incorrect input, comprising:
a memory to store an item, a plurality of existing items, and a match score of each of the plurality of existing items;
an interface to communicate with a user; and
a processor operatively connected to the memory and the interface the processor for running instructions, wherein the processor receives the item input by the user and a request to perform an action using the item via the interface, identifies the plurality of existing items, each existing item related to the requested action, calculates the match score of each existing item, the match score indicating how closely each existing item matches the input item, identifies a closest matching existing item, the closest matching existing item comprising of the existing item which most closely matches the input item, and alerts the user if the match score of the closest matching existing item meets an alert criterion and the closest matching existing item is not an exact match of the input item.

25. The system of claim 24 wherein the input item comprises a telephone number.

26. The system of claim 24 wherein the processor further:
provides the existing item with the greatest match score to the user;
receives an indication from the user, via the interface, whether the associated action should be performed using the existing item with the greatest match score or the input item; and
causes the action to be performed based on the indication received from the user.
